(19) United States
(12) Patent Application Publication
(10) Pub. No.: US 2025/0094233 A1
(43) Pub. Date: Mar. 20, 2025

(54) REQUEST SEGMENTATION FOR REDUCED MEMORY CONSUMPTION BY TRAINED SEQUENTIAL MODELS

(71) Applicant: Microsoft Technology Licensing, LLC, Redmond, WA (US)

(72) Inventors: Wenbin MENG, Bellevue, WA (US); Hemant KUMAR, Bellevue, WA (US); Rakesh KELKAR, Bellevue, WA (US); Karthik RAMAN, Sammamish, WA (US); Sanjay RAMANUJAN, Sammamish, WA (US); Kevin Joseph RIEHM, Woodbury, WA (US); Theodore Dragov TODOROV, Seattle, WA (US)

(21) Appl. No.: 18/470,827

(22) Filed: Sep. 20, 2023

(51) Int. Cl. G06F 9/50

(52) U.S. Cl. CPC G06F 9/5044; G06F 9/5083

(57) ABSTRACT

A disclosed method reduces memory consumption of a trained sequential model. The method includes receiving, from a client application, an initial processing request identifying an input sequence to be processed by the trained sequential model and an initial value for an output size parameter specifying a requested size of output from the trained sequential model. The method further includes sequentially transmitting, to the trained sequential model, multiple partial processing requests based on the initial processing request that each specify a fraction of the initial value as the output size parameter and receiving a sequence of output responses from the trained sequential model generated in response to processing the multiple partial processing requests. The method further provides for returning, to the client application, a final merged response that includes the sequence of output responses.

### BACKGROUND

Certain types of trained machine learning model, such as transformer models, consume significant amounts of memory. Examples of transformer-based models include GPT (Generative Pre-trained Transformer), OPT (Open Pretrained Transformer), and Bloom language model (Bioscience Large Open-science Open-access Multilingual). It is common for transformer models to be provided to end customers as cloud-based software services. The significant graphics processing unit (GPU) utilization of these models makes them expensive to operate and creates challenges pertaining to efficient resource management.

### SUMMARY

According to one implementation, a method is disclosed for reducing memory consumption of a trained sequential model. The method includes receiving, from a client application, an initial processing request identifying an input sequence to be processed by the trained sequential model and an initial value for an output size parameter that represents a requested size of output from the trained sequential model. The method further includes sequentially transmitting, to the trained sequential model, multiple partial processing requests based on the initial processing request that each specify a fraction of the initial value as the output size parameter, and in response, receiving a sequence of output responses from the trained sequential model. The method further provides for returning, to the client application, a final merged response that includes the sequence of output responses.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates example aspects of a sequential natural language processing (NLP) system that implements a request segmentation technique effective to reduce unnecessary memory consumption when utilizing a trained sequential model to execute a workload.

FIG. 2 illustrates another example natural language processing (NLP) system that implements a request segmentation technique effective to reduce unnecessary memory consumption.

FIG. 3 illustrates a plot illustrating a savings in memory consumption that is realized by implementing the herein-disclosed request segmentation logic.

FIG. 4 illustrates example operations for segmenting a processing request into multiple partial processing requests collectively executable by a trained sequential model to yield a same end result as the initial request while realizing a net savings in memory consumption.

FIG. 5 illustrates an example schematic of a processing device suitable for implementing aspects of the disclosed technology.

### DETAILED DESCRIPTION

The high cost and scarcity of GPU resources dramatically increases the cost of deploying large AI models, particularly large language models (LLMs). In existing systems that do deploy these large AI models as cloud-based services, compute resources are often pooled and dynamically assigned to cloud tenants (e.g., requesting applications) on an as-needed basis. Each cloud tenant is allocated some resource quota representing a fractional share of the pooled compute resources supporting the model.

To mitigate operational costs, it is desirable to maximize GPU utilization to the extent possible. Approaches to maximizing GPU utilization commonly pertain to maximizing utilization of shared cloud-based resources such as via techniques that promote efficient quota allocation and management. However, a less-commonly acknowledged inefficiency pertains to unnecessary resource consumption-e.g., scenarios where memory is tied up by a particular process but not being fully used. This is the focus of the herein-disclosed technology.

In the following description, memory in a shared resource pool is referred to as “consumed” when it is either in-use by a tenant workload or otherwise reserved for use by an active tenant workload such that the memory cannot be reserved for or use by other processes. The latter scenario (e.g., reserved but not in-use) is referred to herein as unnecessary resource consumption. In a typical example of unnecessary resource consumption, a chunk of memory is allocated to a particular process but the process uses significantly less than the full chunk of memory for some or all of the time that the process is executing. Notably, the process may require the full chunk of memory for a short period of time, but this period of time is less than the full execution time of the process.

Unnecessary resource consumption occurs due to the fact that memory reservations are typically placed based on the maximum memory that a requesting process is expected to use at any given point in time during processing of the associated workload. Assume, for example, that a web-based chatbot receives the following natural language text string as user input: “create a seven day itinerary for a trip to Paris.” When passing this request of to a cloud-based language model for processing, the chatbot specifies a chunk of memory from a shared resource pool used by the language model that is to be reserved for processing tasks of the workload for the duration of the workload's execution. This requested memory chunk is, in a typical scenario, representative of a maximum (upper bound) on the amount of memory that the chatbot wants to be able to use—if needed—at any given point in time.

For an LLM such as a transformer or transformer-based model trained to perform natural language processing (NLP) tasks, the amount of memory reserved to perform a given processing task is based on the size of text inputs included in the request and also the size of the text outputs generated by the model. As used herein, a “size” of model inputs and outputs can be defined either in terms of memory size (e.g., bytes), string length, or in other units quantifying model output size. In LLM systems, it is common to quantify model inputs and outputs in terms of tokens, where a token represents a basic unit of meaning (e.g., text or code) that the LLM uses to process and generate language. A token can, for example, be a word, punctuation mark, or special character.

The size of text that is to be generated by an LLM processing task is typically specified, at least in part, by the requesting application. For example, the requesting application generates an API call to the LLM that includes an output size parameter identifying a maximum size of output that is requested. The value of the output size parameter size is, in various systems, selected based on different types of criteria such as the identity of the LLM, the type of model (e.g., transformer, seq2seq, RNN), the nature of language processing (NLP) task being requested, and the size of data being operated on. Since it is difficult to intelligently predict the exact data size of model output that will be needed to answer a given LLM input (text query), it is common practice for the specified output size parameter to serve as an upper bound on the permissible length of the model output. In a typical scenario, the model generates outputs until either the outputs reach a predefined size or until a stop logic criterion is satisfied, where both the predefined size and the stop logic criterion are determined based on input parameters specified by the requesting application. For this reason, client applications are, in many cases, programmed to select the output size parameter conservatively by requesting a reservation on a larger chunk of memory than that which is likely to be actually used.

In response to receiving a workload from a client application, an LLM reserves a chunk of memory that is allocated toward execution of the workload. This chunk of memory is selected to be large enough for processing each word included in the textual inputs of the request and also each word of an output string that has a length matching the specified value of the output size parameter. Due to the conservative selection of the output size parameter, it is common for an LLM processing task to be allocated more memory than is actually going to be required at any point in time. In even the very best case scenarios, the memory reserved for a given task will roughly match that which is needed at some point in time during the execution of the task. However, even in these best-case scenarios, it is still unlikely that the processing task will consume all of the allocated memory for the full length of time that the task is executing. This is because the size of the memory chunk reserved was more than that which was actually necessary to accomplish the requested task. In some scenarios, the LLM model encounters a “stop logic criterion,” causing the task to come to a graceful end. For example, the client application specifies both a parameter indicating a size of the requested chunk of memory and one or more stop logic criterion providing conditions that, when met by the output, signify the model to terminate processing.

One can imagine that if a size of text outputs for a particular LLM task were capped to 20,000 words, the reserved memory is populated by those words over time, and it is not until the task is nearly complete that all or substantially all of the reserved memory is actually in-use by the task. A large LLM workload therefore consumes a large chunk of memory for an extended period of time that is populated somewhat linearly (e.g., by storing more and more data as time goes on). However, the entirety of the reserved data chunk is unavailable for use by other processes for the duration of the workload. Consequently, other processes may be negatively affected, albeit indirectly. If, for example, the large LLM workload is requested by a tenant that is subject to a quota on the compute resources utilized by the LLM, this may mean that other workloads submitted by the tenant have reduced resources available, therefore increasing the total time-to-completion for each such process. Alternatively, execution of the large LLM workload may delay the start of other workloads of the same tenant until the large LLM workload has run to completion.

In still further addition to the above-described performance issues that tenants may experience individually, the above-described practices of unnecessary memory consumption (e.g., process allocations that go unused) have the overarching impact of reducing throughput of the LLM as a whole-specifically, by reducing the numbers of tenants and tasks that can be supported by a set pool of shared compute resources.

Still further, all of above-described inefficiencies and performance issues are amplified by the fact that large LLM requests are more susceptible to transient issues on the network level that cause timeouts across the entire request path. This, in turn, extends the time duration that large memory chunks remain consumed and unutilized.

The herein disclosed technology includes request segmentation techniques effective to reduce unnecessary memory consumption by a trained sequential model. This reduction in unnecessary memory consumption reduces operational costs of operating LLMs (e.g., by reducing the quantity of resources needed to service a given request). Additionally, the disclosed techniques improve reliability of cloud-managed LLM systems, reducing the number of request timeouts and request transport issues that occur.

While the following descriptions provide some example applications of the disclosed request segmentation techniques in reference to transformer-based models such as generative pre-training transformers (GPT), the disclosed techniques are believed to be potentially applicable to a variety of types of trained sequential models (e.g., models process data sequentially—e.g., by sequentially processing input sequences and/or sequentially generating output data sequences, such as text streams, audio clips, video-clips, time series data, and other types of sequential data). Other examples of sequence models include seq2seq models, long short-term memory networks (LSTM) recurrent neural networks (RNNs), and transformer models such as generative pre-training transformers (GPT). In one implementation, the disclosed techniques are applied to a language model that has been trained to receive an input sequence and generate an output sequence in an iterative fashion, such as by iteratively predicting a first word following the sequence, then a second word following the sequence, a third word, etc., where each “next word” generated is selected by the model as mathematically most likely to follow the input sequence and/or the previously-generated word(s) in the output sequence. (Models capable applying the disclosed techniques are, in various implementations, trained utilized a variety of techniques including supervised learning, unsupervised learning, and/or reinforcement learning. Further examples of these models and their respective capabilities are provided in the following description.

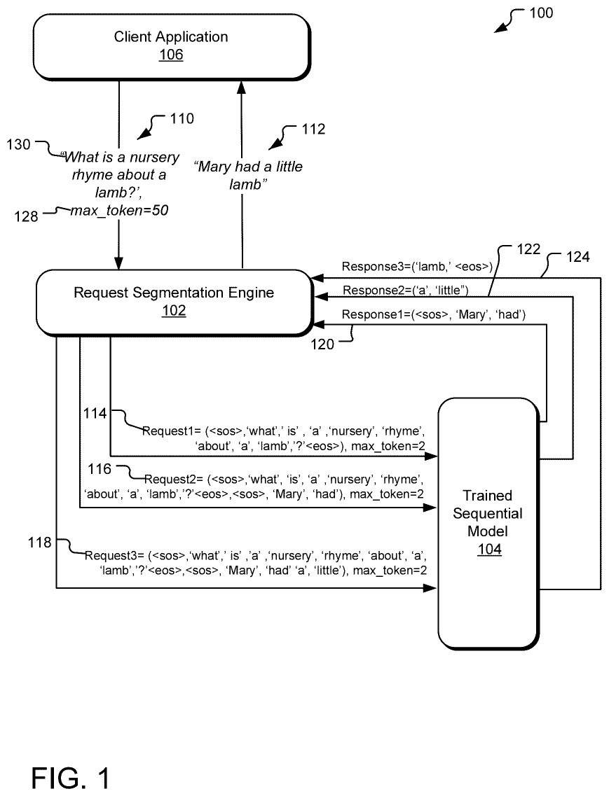

FIG. 1 illustrates example aspects of a sequential natural language processing (NLP) system 100 that implements a request segmentation technique effective to reduce unnecessary memory consumption when utilizing a trained sequential model to execute a workload. The sequential NLP processing system 100 is shown to include a client application 106, a request segmentation engine 102, and a trained sequential model 104. The client application 106 generates processing requests (e.g., a processing request 110) that are delegated to the trained sequential model 104 for execution. The request segmentation engine 102 acts as an intermediary between the client application 106 and the trained sequential model 104 and performs actions for segmenting each processing request generated by the client application into a series of partial processing requests (e.g., partial processing requests 114, 116, 118) that are sequentially provided to and processed by the trained sequential model 104.

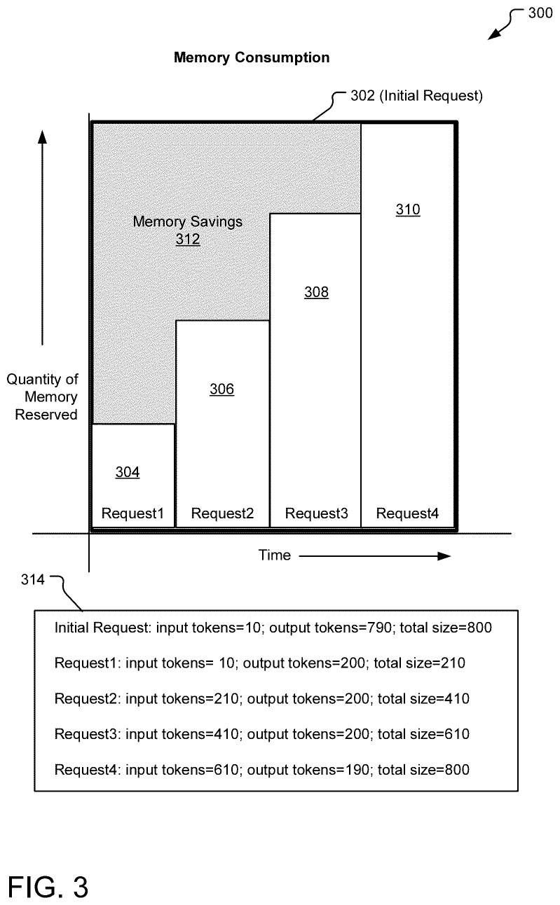

The request segmentation engine 102 appends together outputs of the partial requests to generate a final merged response 112 that is the same or substantially the same as an output that the trained sequential model 104 would have generated if it has been provided with the processing request 110 as-generated by the client application 106 instead of with the series of partial processing requests 114, 116, and 118 generated by the request segmentation engine 102. However, the partial processing requests 114, 116, and 118 are collectively characterized by a lesser quantity of total memory consumption than the memory consumption that would result if the processing request 110 were provided as-generated by the client application 106 to the trained sequential model 104. As used herein, “memory consumption” can be understood as having both a quantity component and temporal component-e.g., a particular quantity of memory allocated to a process multiplied by a period of time that the memory is allocated to a the process (see e.g., FIG. 3 plot).

In FIG. 1, the trained sequential model 104 is shown to be a sequential model that performs sequential natural language processing. However, as mentioned above, the disclosed segmentation techniques could also be applied with similar benefits to trained AI models that process other types of data sequences in a sequential manner. The trained sequential model 104 includes a decoder portion that has been trained to receive a sequence of tokens (e.g., words) and to output a token that is most likely to be observed next in the sequence.

When performing a single NLP task, the decoder portion is iteratively queried with an input sequence that grows in length by one token each iteration. On the first iteration, the decoder input sequence includes the initial input to the model (e.g., the user input). The decoder generates a first word of an output sequence. Then, on the second decoder iteration, the decoder input includes the initial input to the model followed by the first word of the output sequence. The decoder outputs a second word of the output sequence. Then, on the third iteration, the decoder input includes the initial input to the model followed by the first two words of the outputs sequence. The decoder outputs a third word of the output sequence. This continues until the output sequence is completed (e.g., the output sequence reaches a pre-defined cap set on the permissible output size or the trained sequential model 104 otherwise determines that an applicable stop logic criterion is satisfied).

Notably, certain types of models such as GPTs (e.g., GPT-3 and GPT-4 models) implement decoder-only architectures, meaning the above-referenced “decoder portion” is the primary component of the model responsible for processing an output sequence and generating an output sequence. In these architectures, the model receives a sequence as input and performs iterative logic to iterative generate output, one word at a time, as described above. Other types of sequence models, such as RNNs and LSTMs, implement an encoder/decoder architecture. In this architecture, an encoder processes the input sequence to produce a continuous representation, or embedding, of the input before the embedding is provided to a decoder that iteratively generates the output sequence (e.g., one word at a time), in a manner that is generally consistent with the above description. Still other, newer transformer models such as BERT (Bidirectional Encoder Representations from Transformers) and ROBERTa (A Robustly-Optimized BERT training approach) provide encoder-only architectures. While the disclosed request segmentation techniques can be applied to realize similar benefits in all of these types of LLMs, it is to be understood that the exact implementation (e.g., parameters of each of the partial processing requests 114, 116, 118) may vary based on the architecture of the chosen model. These model-to-model variations in application of the disclosed methodology are readily understood by those of skill in the art

Although the disclosed segmentation techniques can be applied to yield a greater savings in memory consumption when applied to particularly large requests (e.g., those with large quantities of input and/or output data), the rudimentary example of FIG. 1 illustrates the disclosed logic applied to a short and simple request. This example is intended to help convey the applied logic but should not be understood as being representative of type of request(s) for which the disclosed technique is likely to yield a notable reduction in memory consumption.

In the example shown, the client application 106 generates the processing request 110 including an input text string 130 to be provided as input to the trained sequential model. Here, the input text string 130 is “what is a nursery rhyme about a lamb?” In addition to the input text string, the processing request 110 also specifies an output size parameter 128 representing a maximum size of output that is being requested from the trained sequential model 104. In FIG. 1 and other examples herein, the output size parameter 128 is specified in units of tokens, where a token is a widely-used basic unit of meaning utilized by LLMs when processing text or code. In one implementation, a token corresponds to a single word or special character and there is, for each different LLM, a known quantity of memory that is needed for a given model to process an individual token. Special characters, such as foreign-language characters, may have a size that is larger than one token, but is assumed their respective conversions are known to the client application 106. In the example shown, the processing request 110 specifies the output size parameter 128 (e.g., “max_token”) which is set to 50 tokens. In an implementation where each token corresponds to one word of model output, this 50 token cap serves to inform the trained sequential model 104 that it is to reserve a quantity of memory sufficient for processing of up to 50 words and use this memory to generate the model output, which has a maximum length of 50 words. One with hindsight into the final merged response 112 (e.g., “Mary had a Little Lamb”, which has a size of 8 tokens) can appreciate that this 50-token reservation is overly conservative and, as a result, an inefficient allocation of memory.

Upon receiving the processing request 110, the request segmentation engine 102 segments the processing request 110 into multiple partial processing requests—e.g., partial processing requests 114, 116, and 118. Each of these three partial processing requests specifies, as input to the trained sequential model 104, the input text string 130 (“What is a nursery rhyme about a lamb?”) as well as the output(s) of the previous partial processing requests associated with the processing request 110 that have already been processed, provided that any exist. Each of the partial processing requests 114, 116, and 116 also specifies a value for the output size parameter that represents some subset of the output size parameter 128 specified by the client application 106.

In the example shown, each of the partial processing requests 114, 116, and 118 specifies a value of “2” tokens for the output size parameter (e.g., “max_token”), which represents a reduction in 48 tokens from the original ‘50’ specified by the client application 106. As is further apparent from the following description and example, the term “partial processing request” is used because each of the partial processing request 114, 116, and 118 essentially asks the trained sequential model 104 to generate a portion of the full response that was requested by the initial processing request 110.

The partial processing request 114 provides the trained sequential model 104 with the input text string 130 (e.g., “what is a nursery rhyme about a lamb”) and sets the output size parameter to 2 tokens, which serves to inform the trained sequential model 104 that it is permitted to generate a maximum output of 2 tokens. In response to receipt of the partial processing request 114, the trained sequential model 104 reserves a quantity of memory that is equivalent that needed to process the eight-token input text string plus two tokens of output. For example, the trained sequential model 104 includes a resource management component (not shown) that converts requested tokens (e.g., the size of the input text string plus the specified value of the output data size) to a quantity of memory identified, by a predefined conversion, as sufficient to store the requested tokens. This memory is allocated to the partial processing request 114 and is therefore unavailable to process other requests until the partial processing request 114 has finished executing.

In response to the first partial processing request 114, the trained sequential model 104 outputs a first response 120 that includes two tokens—“Mary had”. Although not shown in FIG. 1, some implementations of the trained sequential model 104 include a “finish reason” parameter within each model output. For example, the first response 120 includes the output string “Mary had” in addition to a finish reason parameter, “finish_reason=length,” which indicates that the model has stopped processing because the output size has reached the limit specified by the output size parameter 128 (e.g., because the outputs have reached the specified “max_token” size). When the model stops processing for other reasons, such as because a stop logic criterion set has been encountered, the “finish_reason” parameter assumes another value, such as “stop”). In scenarios where the finish reason is indicative of the output token size reaching the output size parameter 128 (e.g., finish_reason=length), the request segmentation engine 102 generates another partial processing request.

In the illustrated example, the request segmentation engine 102 determines that the first partial processing request 114 has finished because the generated output has a size matching the output size parameter 128. Consequently, the request segmentation engine 102 generates and transmits a second partial processing request 116 that includes the input text string 130 and the first response 120, in sequential order (e.g., “what is a nursery rhyme about a little lamb? Mary had”). Like this first partial processing request 114, the second partial processing request 116 also sets the output size parameter to a quantity representing some remaining (unprocessed) subset of the initially-requested model output size. In the simplified example, this quantity is again 2 tokens, representing a permissible maximum output of two words.

The trained sequential model 104 processes the ten-word input text string in the second partial processing request 116 and generates a second response 122 including the next two words of the output sequence (“a little”). Upon receiving the second response 122, the request segmentation engine 102 generates and transmits a third partial processing request 118 that includes twelve words including the initial input text string, the first response 120, and the second response 122, in sequential order (e.g., “what is a nursery rhyme about a little lamb? Mary had a little”). This third partial processing request 118 also sets the output size parameter to two tokens, permitting—yet again—generation of up two new words of output.

The trained sequential model 104 processes the twelve-word input text string in the third sequential partial processing request 118 and generates a third response 124 that includes a single word (“lamb”) of new output. Although not shown in FIG. 1, this third response 124 may, in some implementations, include a finish reason parameter set to a value that indicates model processing has stopped for some reason other than the output size reaching the specified output size parameter 128. In response to detection of this value within the third response 124, the segmentation engine 102 determines that the processing request 110 has been fully processed by the model and prepares the final merged response 112 by sequentially appending together the first response 120, the second response 122, and the third response 124.

If the input string 110 had been processed subject to the output size parameter 128 in the processing request 110, the resulting memory reservation would have tied up a chunk of memory large enough to process the initial eight input tokens plus the requested 50 tokens of output (e.g., 58 total tokens). However, by segmenting the processing request 110 into partial processing requests that each specifies a smaller output data size (e.g., 2 tokens instead of 50), the largest memory reservation placed had the effect of tying-up a much smaller chunk of memory. In this case, the largest memory reservation placed was in association with the third partial processing request 118, and the quantity of memory reserved was equivalent to that needed to process twelve words of input and two words of output (12+2=14 tokens).

In the above example, a reduction in the peak resource consumption is observed from an overly-conservative 58 tokens the initial processing request 110 to just 14 tokens for the third partial processing request 118, with even fewer tokens being consumed during execution of the first processing request 114 and the second processing request 116. In effect, this partial processing request methodology enables a single initial request to be segmented into sequential requests that incrementally reserve more and more memory until the “right” amount of memory is discovered and consumed.

In addition to the memory consumption savings potentially realized by placing more accurate (and less overly-conservative) memory reservations, the piece-wise approach of submitting multiple requests actually allows the maximum consumption peak to be reached for a shorter length of time than it would be even if the client application 106 had requested the appropriate number of tokens (e.g., 14) instead of the overly-conservative number (e.g., 58 tokens). That is due to the fact that the peak token consumption (14 tokens) occurred during processing of third sequential partial processing request 118 (e.g., while the last word of output was being generate) while fewer total tokens were consumed during the time period in which the earlier words in the final merged response 112 were being generated. This savings is also illustrated visually with respect to FIG. 3, below.

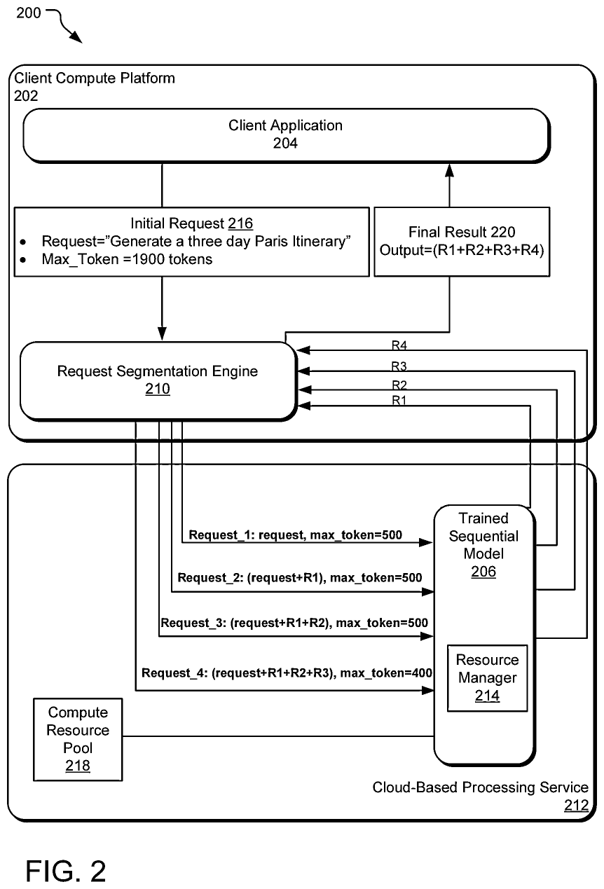

FIG. 2 illustrates another example natural language processing (NLP) system 200 that implements a request segmentation technique effective to reduce unnecessary memory consumption. The segmentation technique with respect to FIG. 2 is the same or substantially similar to the technique described above with respect to FIG. 1; however, additional system components are shown and described to provide additional exemplary context for the environment in which the disclosed techniques are applicable.

The NLP system 200 includes a trained sequential model 206 implemented in a cloud architecture. The trained sequential model 206 is, for example, a transformer-type model such as a GPT model or BERT, that executes workloads received from client applications that originate at client platforms (e.g., devices owned by end users or cloud resources configured on behalf of those end users). The trained sequential model 206 is shown residing within a cloud-based processing service 212 that includes a compute resource pool 218. The compute resource pool 218 includes computer hardware, such as GPUs, CPUs, and memory, that are shared by multiple tenants sending respective workloads to the trained sequential model 206.

The cloud-based processing service 212 is shown interfacing with a client compute platform 202, which may be understood as managed and used by a tenant (e.g., a development team). In some implementations, the tenant is allotted a set quota of compute resources from the compute resource pool 218, where the set quota represents the maximum consumption that the tenant is permitted at any individual point in time. In these systems, the cloud-based processing service 212 includes a quota management component (not shown) that dynamically monitors resource consumption, evaluates incoming processing requests in view of current consumption and client quota limits, selectively denies incoming processing requests determined to exceed quota limits, and places resource reservations for those requests that are not determined to exceed quota limits.

In the NLP system 200, reservations on the compute resources in the compute resource pool 218 are managed by a resource manager 214, which is (for ease of visualization) shown to be a subcomponent of the trained sequential model 206. In implementations that also allocate quota and enforce quota limits, the resource manager 214 may perform some or all actions described above with respect to the “quota management component.” Since quota allocation and enforcement is not a required functionality of a system implementing the disclosed technology, it is assumed in the following example, that quota limits are a non-issue and that each request received at the resource manager 214 effects a reservation on a quantity of compute resources within the compute resource pool 218.

The system 200 further includes a request segmentation engine 210 that performs segmentation actions the same or similar to those described with respect to FIG. 1. This request segmentation engine is shown executing on the client compute platform 202. In another implementation, the request segmentation engine 210 is a cloud component managed by a provider of the trained sequential model 206.

The client application 204 generates a request for processing by the trained sequential model 206. In the illustrated example, the client application 204 generates an initial request 216 that specifies an input sequence (e.g., “generate a three day Paris itinerary”) and that also specifies an initial value for an output size parameter (e.g., “max_token=1900”). The output size parameter designates a maximum size of data, in units of tokens, that is to be output by the trained sequential model 206. The resource manager 214 is programmed with logic for converting each token to a quantity physical compute resources is consumed when processing the token. Using this conversion, the resource manager 214 is capable of determining an amount of memory capable of processing the six-token input string and 1900 tokens of requested output.

In one implementation, the request segmentation engine 210 applies request segmentation logic conditionally based on a determined size of each received request in terms of the number of input and output tokens. If, for a given request, the sum of the input tokens and requested output tokens is less than a defined threshold (e.g., a predefined “chunk size”—as discussed further below), the request segmentation engine 210 forwards the request to the trained sequential model 206 without performing any further processing. If, on the other hand, the sum of the input token and requested output tokens exceeds the defined threshold, the request segmentation engine 210 performs the segmentation operations illustrated in FIG. 2.

Provided that the size of the request is determined to exceed the set threshold, the request segmentation engine generates a series of partial processing request (“Request 1, Request 2, Request 3, and Request 4), with each request in the sequence being generated and transmitted in response to receipt of output from the previous request.

The output size parameter (max token) is, in each of the partial processing requests, set to a token quantity—referred to as a chunk size—that represents a “chunk” (e.g., subset) of the initial value in the initial request 216. The chunk size utilized is variable from one implementation to another and is, in some implementations, request-specific. For example, the chunk size is selected to reduce the output size parameter (max_token) to a set fraction of its initial value, such as half, one-third, one-quarter, or even less. In other implementations, the chunk size is statically defined. For example, the request segmentation engine 210 utilizes 500 tokens as a default chunk size in all partial processing requests transmitted in association with a given input request unless a difference between an initial value of output size parameter and the number of already-processed output tokens is less than the default chunk size, as is in the example of FIG. 2 (e.g., where the request segmentation engine 210 is shown using a default chunk size of 500 tokens for the first three partial processing requests and 400 for the last request because 2000−500−500−500=400, which is less than the chunk size of 500).

The default chunk size ensures that the herein disclosed segmentation techniques are performed on requests having a token size that exceeds a threshold, where the “token size” is either the requested number of output tokens or the sum of input prompt tokens and the requested output tokens. The threshold is, in one implementation, set based on a distribution of the token size for each of many requests received by the trained sequential model 206 over a period of time. For example, the request segmentation engine 210 sets the default chunk size to equal the P90 or P95 percentile value of the specified “max_token” parameter across a distribution of requests received by the trained sequential model 104. This has the effect of selectively subjecting requests that are in the top 5-10% in terms of size to segmentation processing, as described below.

Notably, the herein disclosed request segmentation techniques yield the greatest benefits, including improved reliability with fewer timeouts and request transport issues, when applied to processing requests having the largest token size (e.g., those in the top 10% or so). These benefits are attributable to the segmentation of a single request into multiple partial processing requests that are, in turn, executed sequentially to generate different portions of the output sequence. Individually, some or all of the multiple partial requests effect reservations of memory chunks that are smaller than the corresponding chunk of memory needed to process the single request; consequently, these smaller chunks of memory are reserved for some of the total request processing time in lieu of a larger memory chunk for the entire duration of the time. A detailed illustration of memory savings on account of these operations is shown and discussed with respect to FIG. 3, with descriptive emphasis on the reason for memory savings.

While some improvements in reliability may be observed when the disclosed segmentation technique is applied to smaller requests, these gains diminish in proportion to the token size of the request, and there is a point when the latency reduction attributable to request segmentation is outweighed by a slight latency gain attributable to segmentation processing performed by the request segmentation engine 210.

In the example shown, the logic applied by the request segmentation engine 210 is substantially similar or identical to that described with respect to FIG. 1. The request segmentation engine 210 generates a first partial processing request, Request_1, that is identical to the initial request 216 except for the value of the output size parameter (max_token), which has been reduced from the 1900 tokens specified in the initial request to a select chunk size of 500 tokens. In addition, the first partial processing request includes the initial text string (“Generate a three day Paris Itinerary”), referenced as “Request” in both FIG. 2 and the following description. The trained sequential model 206 executes the first partial processing request, Request_1, and outputs a first response, R1, that has a length of 500 tokens.

Following receipt of R1, the request segmentation engine 210 generates and transmits a second partial processing request, Request_2 to the trained sequential model 206. The input text string specified in Request_2 includes the Request (“Generate a three day Paris Itinerary”) and R1 (e.g., the first 500 tokens of output are appended to the end of the request), with R1 being appended to the end of the Request. The trained sequential model 206 executes the second partial processing request, Request_2, and outputs a second response, R2, that again has a length of 500 tokens.

Following receipt of R2, the request segmentation engine 210 generates and transmits a third partial processing request, Request_3. The input text string specified in Request_3 includes the Request (“Generate a three day Paris Itinerary”), R1, and R2, with R1 being appended to the end of the Request and R2 being appended to the end of R1. The trained sequential model 206 executes the third partial processing request, Request_3, and outputs a third response, R3, that again has a length of 500 tokens.

Following receipt of R3, the request segmentation engine 210 recognizes that all but 400 tokens of requested output have now been processed. Of the 1900 output tokens initially requested, 1500 have already been generated. Consequently, the request segmentation engine 210 reduces the chunk size being used for the output size parameter (max_token) from 500 to 400 so as to not reserve more memory for this final request than that which corresponds to the total token consumption of the initial request 216 (e.g., the sum of input tokens and requested output). The request segmentation engine 210 transmits a final, fourth partial processing request, Request_4. The input text string specified in Request_4 includes the Request, R1, R2, and R3 all appended to one another in the order shown (e.g., in order of generation). In response, the trained sequential model 206 executes the fourth partial processing request, Request_4, and outputs a fourth response, R4, that has a length less than or equal to the specified output size parameter of 400 or fewer. Notably, the trained sequential model 206 may output fewer than the requested number of output tokens (fewer than the “max_token” value) in scenarios where the trained sequential model 206 reaches a defined stop logic criterion (e.g., that was specified by the requesting application) or otherwise self-determines that the response has reached a natural termination point, with the “natural termination point” being identified based on logic that is model-specific and generally known in the art.

The request segmentation engine 210 creates a final output string by appending together the responses (R1, R2, R3, R4) received form the partial processing requests (Request_1, Request_2, Request_3, Request_4) in order of receipt. This final output string is returned as final merged response 220 to the client application 204. Notably, some implementations of the trained sequential model 206 are configured to return more than just a text output string that is generated based on an input text prompt. For example, some models return usage statistics such the number of tokens actually generated, log probabilities of the requested tokens, etc. In one implementation, the request segmentation engine 210 performs processing operations to aggregate these other nominal model outputs such that final result output to the client application 204 (e.g., output string plus this additional information) has a format that the client application 204 expects to receive from a single processing result output by the model. That is, the request segmentation engine 210 merges/aggregates all model outputs from the partial processing requests and formats the result in a way that permits client application 204 to remain completely agnostic to the fact that the initial request 216 was processed as multiple partial process requests.

FIG. 3 illustrates a plot 300 illustrating a savings in memory consumption that is realized by implementing the herein-disclosed request segmentation logic. A y-axis of the plot 300 illustrates memory allocated to a given process. The x-axis illustrate changes in that memory allocation over time-namely, from the beginning and the end of the process. A consumption block 302 (e.g., rectangle bounding the entire plot 300) is representative of total memory consumption that occurs when a trained sequential model executes a request according to parameters specified by an application that generated the request. This request is, in this example, referred to as the “initial request”.

The consumption blocks 304, 306, 308, and 310 are representative of total memory consumption resulting from each of multiple partial processing requests generated by, by a request segmentation engine, based on the initial request and using the same or similar request segmentation logic as that described above with respect to the request segmentation engine 210 of FIG. 2 or the request segmentation engine 102 of FIG. 1.

Notably, a key 314 below the plot 300 illustrates the input token size, output token size, and total token size of the initial request as well as for each of the four partial processing requests (Request1-Request4). In this example, the initial request includes a 10 token input string and requests 790 tokens of output. The total size of the initial request in terms of tokens is therefore 10+790=800. When this request is received by a trained sequential model, the request size (800 tokens) is converted to a corresponding quantity of memory that is, in turn, reserved for processing of the initial request. The amount of memory needed to process each individual token (of both input and output) is presumed to be known to the model, and readily available for determining the quantity of resources to reserve in association with each request.

In the example shown, a sequence of partial processing requests (Request1-Request5) is executable to generate the same end result as that produced via execution of the initial request. Like the other examples provided herein, the first partial processing request (Request 1) includes same input string as the initial request but requests a fewer number of output tokens—specifically, Request 1 requests 200 output tokens instead of the 790 requested in the initial request. The total token size of Request1 is therefore 200+10=210. The consumption block 304 represents a consumption of memory corresponding the processing of 10 input tokens and 200 output tokens.

The second partial processing request, Request2, has a number of input tokens equal to 210 because the input string is, in this case, the original input string (10 tokens) appended to the output from the previous query (200 tokens). This requested number of output tokens is again 200 tokens, making the total size of the request 410 tokens. The consumption block 306 represents a consumption of memory corresponding to 410 tokens, where 210 are processed as input and 200 are generated as output.

Request3 and Request4 each incrementally increase in total request size by 200 tokens each because, as above, each of these partial processing requests an input token size equal to the total size of the previous request and requests 200 tokens of new output. Notably, this incremental increase in total request size causes Request4 to have a same total token size of 800 tokens as the initial request.

Because Request4 and the initial request are of the same total token size, both requests effect a reservation for a same quantity of memory. Consequently, the corresponding consumption blocks 302 and 310 therefore have the same height. Notably, however, the 800 token size of Request4 is actually broken down into 610 tokens of input and 200 tokens of output, whereas the initial request included 10 tokens of input and 790 tokens of output. Since it takes a longer amount of time for the sequential model to process output tokens than input tokens, Request 4 can be executed in significantly less time than the initial request (as illustrated by the x-axis differences in width of the consumption blocks 302 and 310). Thus, while the peak consumption observed during the segmented request approach (spanning Request1-Request4) corresponds to a same quantity of memory as that reserved during the processing of the initial request, this peak consumption spans a shorter period of time than the execution time the initial request. Moreover, since the total token size of each of Request1, Request2, and Request3 is smaller than the token size of the initial request, less memory is reserved during the period of time that these requests execute as compared to time block in which the corresponding (same) sequence of outputs is generated during processing of the initial request.

As a result of the above, a net savings in memory consumption is actually realized during the execution of Request1, Request2, and Request3, when the quantity of memory reserved is below the peak. A shaded region 312 represents a total savings in memory consumption that is realized when the request is segmented and processed as described above (e.g., as Request1-Request4) as compared to when the request is not segmented as processed as a single request (e.g., as the initial request).

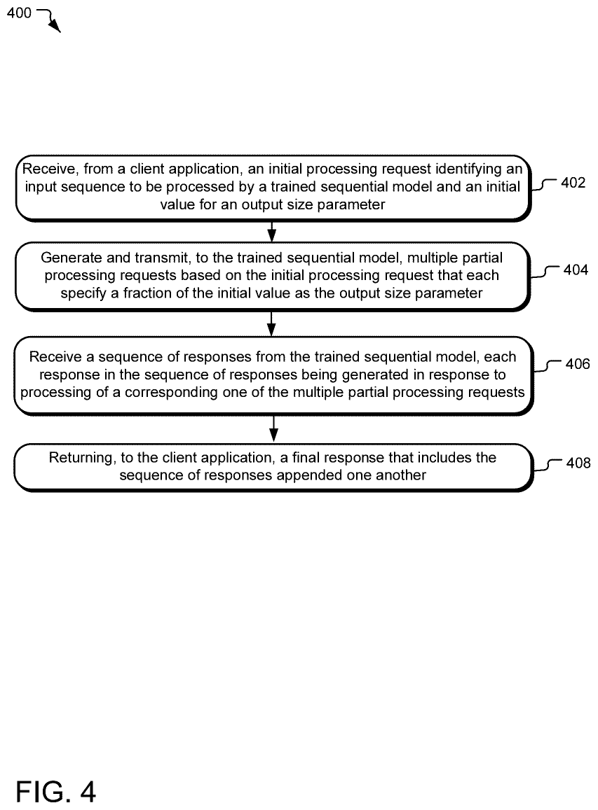

FIG. 4 illustrates example operations 400 for segmenting a processing request into multiple partial processing requests collectively executable by a trained sequential model to yield a same end result as the initial request while realizing net savings in memory consumption. A receiving operation 402 receives, from a client application, an initial processing request identifying an input sequence to be processed by a trained sequential model and an initial value for an output size parameter, where the output size parameter represents a size of output requested from the trained sequential model. A generation and transmission operation 404 generates multiple sequential partial processing requests based on the initial processing request that each specify a fraction of the initial value as the output size parameter.

A receiving operation 406 receives a sequence of responses from the trained sequential model, each of the responses being generated in response to processing of a corresponding one of the multiple partial processing requests, and a returning operation returns, to the client application, a final merged response that includes the sequence of responses appended to one another.

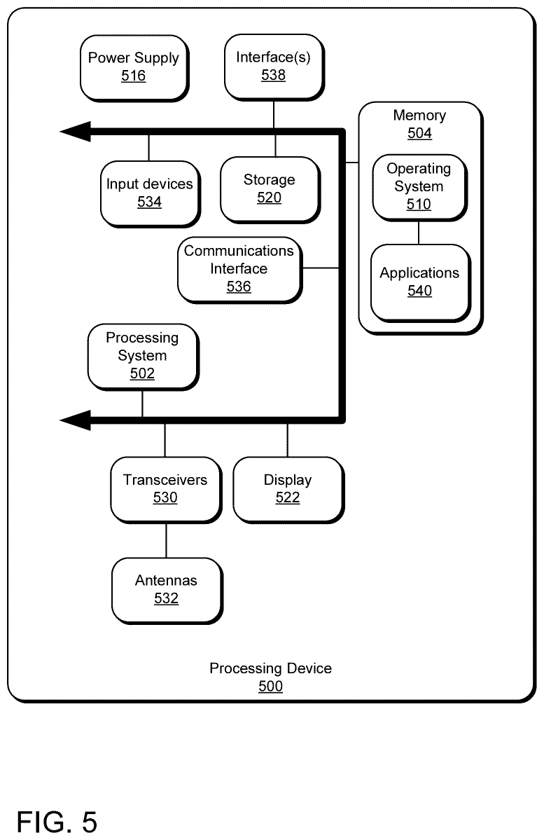

FIG. 5 illustrates an example schematic of a processing device 500 suitable for implementing aspects of the disclosed technology. The processing device 500 includes one or more processor unit(s) 502, memory device(s) 504, a display 506, and other interfaces 508 (e.g., buttons). The processor unit(s) 502 may each include one or more CPUs, GPUs, etc.

The memory device(s) 504 generally includes both volatile memory (e.g., RAM) and non-volatile memory (e.g., flash memory). An operating system 510, such as the Microsoft Windows® operating system, the Microsoft Windows® Phone operating system or a specific operating system designed for a gaming device, resides in the memory device(s) 504 and is executable by the processor unit(s) 502, although it should be understood that other operating systems may be employed.

One or more applications 512 (e.g., the request segmentation engine of FIG. 2, the trained sequential model 206 of FIG. 2) are loaded in the memory device(s) 504 and executed on the operating system 510 by the processor unit(s) 502. The applications 512 may receive inputs from one another as well as from various input local devices such as a microphone 534, input accessory 535 (e.g., keypad, mouse, stylus, touchpad, gamepad, racing wheel, joystick), and a camera 532. Additionally, the applications 512 may receive input from one or more remote devices, such as remotely-located smart devices, by communicating with such devices over a wired or wireless network using more communication transceivers 530 and an antenna 538 to provide network connectivity (e.g., a mobile phone network, Wi-Fi®, Bluetooth®). The processing device 500 may also include one or more storage devices 528 (e.g., non-volatile storage). Other configurations may also be employed.

The processing device 500 further includes a power supply 516, which is powered by one or more batteries or other power sources and which provides power to other components of the processing device 500. The power supply 516 may also be connected to an external power source (not shown) that overrides or recharges the built-in batteries or other power sources.

The processing device 500 may include a variety of tangible computer-readable storage media and intangible computer-readable communication signals. Tangible computer-readable storage can be embodied by any available media that can be accessed by the processing device 500 and includes both volatile and nonvolatile storage media, removable and non-removable storage media. Tangible computer-readable storage media excludes intangible and transitory communications signals and includes volatile and nonvolatile, removable, and non-removable storage media implemented in any method or technology for storage of information such as computer readable instructions, data structures, program modules or other data. Tangible computer-readable storage media includes RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 500. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, intangible communication signals include wired media such as a wired network or direct-wired connection, and wireless media such as acoustic, RF, infrared and other wireless media.

Some implementations may comprise an article of manufacture. An article of manufacture may comprise a tangible storage medium (a memory device) to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled and/or interpreted programming language.

In some aspects, the techniques described herein relate to a method for reducing memory consumption of a trained sequential model, the method including: receiving, from a client application, an initial processing request identifying an input sequence to be processed by the trained sequential model and an initial value for an output size parameter, the output size parameter representing a requested size of output from the trained sequential model; sequentially transmitting, to the trained sequential model, multiple partial processing requests based on the initial processing request that each specify a fraction of the initial value as the output size parameter; receiving a sequence of output responses from the trained sequential model, each response in the sequence of output responses being generated in response to processing of a corresponding one of the multiple partial processing requests; and returning, to the client application, a final merged response including the sequence of output responses formatted to match expected response output associated with the initial processing request.

In some aspects, the techniques described herein relate to a method, wherein the fraction of the initial value specified for the output size parameter in each different one of the multiple partial processing requests collectively sum to the initial value.

In some aspects, the techniques described herein relate to a method, wherein each of the multiple partial processing requests further includes the input sequence.

In some aspects, the techniques described herein relate to a method, wherein the multiple partial processing requests include a first partial processing request and one or more additional partial processing requests, each of the one or more additional partial processing requests identifying a subset of the sequence of output responses generated during processing of previous requests of the multiple partial processing requests.

In some aspects, the techniques described herein relate to a method, wherein transmitting, to the trained sequential model, multiple partial processing requests includes: transmitting, to the trained sequential model, a first partial processing request that includes the input sequence; receiving a first processing result in response to processing of the first partial processing request, the first processing result including a first output sequence corresponding to a first sequential portion of the final merged response; transmitting, to the trained sequential model, a second partial processing request that includes the input sequence and the first output sequence; and receiving, from the trained sequential model, a second processing result in response processing of the second partial processing request, the second processing result including the first output sequence and a second output sequence corresponding to a second sequential portion of the final merged response, wherein the final merged response includes the second output sequence appended to the first output sequence.

In some aspects, the techniques described herein relate to a method, wherein the trained sequential model is a generative transformer-based model.

In some aspects, the techniques described herein relate to a method, wherein transmitting of the multiple partial processing requests is performed by a client device executing the client application.

In some aspects, the techniques described herein relate to a system for reducing memory consumption of a trained sequential model including: a request segmentation engine stored in memory and executable to: receive, from a client application, an initial processing request identifying an input sequence for processing by a trained sequential model and an initial value for an output size parameter, the output size parameter representing a requested size of output from the trained sequential model; transmit, to the trained sequential model, multiple partial processing requests based on the initial processing request, each of the multiple partial processing requests specifying a fraction of the initial value as the output size parameter; receiving a sequence of output responses from the trained sequential model, each response in the sequence of output responses being generated in response to processing of one of the multiple partial processing requests; and returning, to the client application, a final merged response that includes the sequence of output responses formatted to match expected response output associated with the initial processing request.

In some aspects, the techniques described herein relate to a system, wherein the fraction of the initial value specified for the output size parameter in each different one of the multiple partial processing requests collectively sum to the initial value.

In some aspects, the techniques described herein relate to a system, wherein each of the multiple partial processing requests further includes the input sequence.

In some aspects, the techniques described herein relate to a system, wherein the multiple partial processing requests include a first partial processing request and one or more additional partial processing requests, each of the one or more additional partial processing requests including a subset of the sequence of output responses generated during processing of previous requests of the multiple partial processing requests.

In some aspects, the techniques described herein relate to a system, wherein the multiple partial processing requests further include a first partial processing request that includes the input sequence and a second partial processing request that includes the input sequence appended to a first output sequence generated by the trained sequential model based on the first partial processing request.

In some aspects, the techniques described herein relate to a system, wherein the sequence of output responses includes the first output sequence and a second output sequence generated by the trained sequential model based on the second partial processing request.

In some aspects, the techniques described herein relate to a system, wherein the trained sequential model is a transformer model with a decoder-only architecture.

In some aspects, the techniques described herein relate to a system, wherein the request segmentation engine is executed on a same a client device that executes the client application.

In some aspects, the techniques described herein relate to one or more tangible computer-readable storage media encoding computer-executable instructions for executing a computer process for reducing resource consumption of a trained sequential model, the computer process including: receiving, from a client application, an initial processing request identifying an input sequence to be processed by the trained sequential model and an initial value for an output size parameter, the output size parameter representing a requested size of output from the trained sequential model; transmitting, to the trained sequential model, multiple partial processing requests based on the initial processing request that each specify a fraction of the initial value as the output size parameter; receiving a sequence of output responses from the trained sequential model, each response in the sequence of output responses being generated in response to processing of one of the multiple partial processing requests; and returning, to the client application, a final merged response that includes the sequence of output responses formatted to match expected response output associated with the initial processing request.

In some aspects, the techniques described herein relate to one or more tangible computer-readable storage media, wherein the fraction of the initial value specified for the output size parameter in each different one of the multiple partial processing requests collectively sum to the initial value.

In some aspects, the techniques described herein relate to one or more tangible computer-readable storage media, wherein each of the multiple partial processing requests further includes the input sequence.

In some aspects, the techniques described herein relate to one or more tangible computer-readable storage media, wherein the multiple partial processing requests include a first partial processing request and one or more additional partial processing requests, each of the one or more additional partial processing requests identifying a subset of the sequence of output responses generated during processing of previous requests of the multiple partial processing requests.

In some aspects, the techniques described herein relate to one or more tangible computer-readable storage media, wherein transmitting, to the trained sequential model, multiple partial processing requests includes: transmitting, to the trained sequential model, a first partial processing request that includes the input sequence; receiving a first processing result in response to processing of the first partial processing request, the first processing result including a first output sequence corresponding to a first sequential portion of the final merged response; transmitting, to the trained sequential model, a second partial processing request that includes the input sequence and the first output sequence; and receiving, from the trained sequential model, a second processing result in response processing of the second partial processing request, the second processing result including the first output sequence and a second output sequence corresponding to a second sequential portion of the final merged response, wherein the final merged response includes the second output sequence appended to the first output sequence.

In some aspects, the techniques described herein relate to a system for reducing memory consumption of a trained sequential model including: a means for receiving, from a client application, an initial processing request identifying an input sequence for processing by a trained sequential model and an initial value for an output size parameter, the output size parameter representing a requested size of output from the trained sequential model; a means for transmitting to the trained sequential model, multiple partial processing requests based on the initial processing request, each of the multiple partial processing requests specifying a fraction of the initial value as the output size parameter; a means for receiving a sequence of output responses from the trained sequential model, each response in the sequence of output responses being generated in response to processing of one of the multiple partial processing requests; and a means for returning, to the client application, a final merged response that includes the sequence of output responses formatted to match expected response output associated with the initial processing request.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of example implementations.

What is claimed is:

1. A method for reducing memory consumption of a trained sequential model, the method comprising:
receiving, from a client application, an initial processing request identifying an input sequence to be processed by the trained sequential model and an initial value for an output size parameter, the output size parameter representing a requested size of output from the trained sequential model;
sequentially transmitting, to the trained sequential model, multiple partial processing requests based on the initial processing request that each specify a fraction of the initial value as the output size parameter;
receiving a sequence of output responses from the trained sequential model, each response in the sequence of output responses being generated in response to processing of a corresponding one of the multiple partial processing requests; and
returning, to the client application, a final merged response including the sequence of output responses formatted to match expected response output associated with the initial processing request.

2. The method of claim 1, wherein the fraction of the initial value specified for the output size parameter in each different one of the multiple partial processing requests collectively sum to the initial value.

3. The method of claim 1, wherein each of the multiple partial processing requests further includes the input sequence.

4. The method of claim 1, wherein the multiple partial processing requests include a first partial processing request and one or more additional partial processing requests, each of the one or more additional partial processing requests identifying a subset of the sequence of output responses generated during processing of previous requests of the multiple partial processing requests.

5. The method of claim 1, wherein transmitting, to the trained sequential model, multiple partial processing requests includes:
transmitting, to the trained sequential model, a first partial processing request that includes the input sequence;
receiving a first processing result in response to processing of the first partial processing request, the first processing result including a first output sequence corresponding to a first sequential portion of the final merged response;
transmitting, to the trained sequential model, a second partial processing request that includes the input sequence and the first output sequence; and
receiving, from the trained sequential model, a second processing result in response processing of the second partial processing request, the second processing result including the first output sequence and a second output sequence corresponding to a second sequential portion of the final merged response, wherein the final merged response includes the second output sequence appended to the first output sequence.

6. The method of claim 1, wherein the trained sequential model is a generative transformer-based model.

7. The method of claim 1, wherein transmitting of the multiple partial processing requests is performed by a client device executing the client application.

8. A system for reducing memory consumption of a trained sequential model comprising:
a request segmentation engine stored in memory and executable to:
receive, from a client application, an initial processing request identifying an input sequence for processing by a trained sequential model and an initial value for an output size parameter, the output size parameter representing a requested size of output from the trained sequential model;
transmit, to the trained sequential model, multiple partial processing requests based on the initial processing request, each of the multiple partial processing requests specifying a fraction of the initial value as the output size parameter;
receiving a sequence of output responses from the trained sequential model, each response in the sequence of output responses being generated in response to processing of one of the multiple partial processing requests; and
returning, to the client application, a final merged response that includes the sequence of output responses formatted to match expected response output associated with the initial processing request.

9. The system of claim 8, wherein the fraction of the initial value specified for the output size parameter in each different one of the multiple partial processing requests collectively sum to the initial value.

10. The system of claim 8, wherein each of the multiple partial processing requests further includes the input sequence.

11. The system of claim 10, wherein the multiple partial processing requests include a first partial processing request and one or more additional partial processing requests, each of the one or more additional partial processing requests including a subset of the sequence of output responses generated during processing of previous requests of the multiple partial processing requests.

12. The system of claim 10, wherein the multiple partial processing requests further include a first partial processing request that includes the input sequence and a second partial processing request that includes the input sequence appended to a first output sequence generated by the trained sequential model based on the first partial processing request.

13. The system of claim 12, wherein the sequence of output responses includes the first output sequence and a second output sequence generated by the trained sequential model based on the second partial processing request.

14. The system of claim 8, wherein the trained sequential model is a transformer model with a decoder-only architecture.

15. The system of claim 8, wherein the request segmentation engine is executed on a same a client device that executes the client application.

16. One or more tangible computer-readable storage media encoding computer-executable instructions for executing a computer process for reducing resource consumption of a trained sequential model, the computer process comprising:
receiving, from a client application, an initial processing request identifying an input sequence to be processed by the trained sequential model and an initial value for an output size parameter, the output size parameter representing a requested size of output from the trained sequential model;
transmitting, to the trained sequential model, multiple partial processing requests based on the initial processing request that each specify a fraction of the initial value as the output size parameter;
receiving a sequence of output responses from the trained sequential model, each response in the sequence of output responses being generated in response to processing of one of the multiple partial processing requests; and
returning, to the client application, a final merged response that includes the sequence of output responses formatted to match expected response output associated with the initial processing request.

17. The one or more tangible computer-readable storage media of claim 16, wherein the fraction of the initial value specified for the output size parameter in each different one of the multiple partial processing requests collectively sum to the initial value.

18. The one or more tangible computer-readable storage media of claim 16, wherein each of the multiple partial processing requests further includes the input sequence.

19. The one or more tangible computer-readable storage media of claim 16, wherein the multiple partial processing requests include a first partial processing request and one or more additional partial processing requests, each of the one or more additional partial processing requests identifying a subset of the sequence of output responses generated during processing of previous requests of the multiple partial processing requests.

20. The one or more tangible computer-readable storage media of claim 16, wherein transmitting, to the trained sequential model, multiple partial processing requests includes:
transmitting, to the trained sequential model, a first partial processing request that includes the input sequence;
receiving a first processing result in response to processing of the first partial processing request, the first processing result including a first output sequence corresponding to a first sequential portion of the final merged response;
transmitting, to the trained sequential model, a second partial processing request that includes the input sequence and the first output sequence; and
receiving, from the trained sequential model, a second processing result in response processing of the second partial processing request, the second processing result including the first output sequence and a second output sequence corresponding to a second sequential portion of the final merged response, wherein the final merged response includes the second output sequence appended to the first output sequence.
